(19) United States
(12) Patent Application Publication
(10) Pub. No.: US 2015/0042634 A1
(43) Pub. Date: Feb. 12, 2015

(54) ORGANIC LIGHT EMITTING DIODE DISPLAY

(71) Applicant: Samsung Display Co., Ltd., Yongin-city (KR)

(72) Inventors: Guang-Hai JIN, Yongin-City (KR); Jae-Beom Choi, Yongin-City (KR); Jae Hwan Oh, Yongin-City (KR); Seong-Hyun Jin, Yongin-City (KR)

(73) Assignee: Samsung Display Co., Ltd., Yongin-city (KR)

(21) Appl. No.: 14/254,380

(22) Filed: Apr. 16, 2014

(30) Foreign Application Priority Data
Aug. 6, 2013 (KR) 10-2013-0093179

(51) Int. Cl. G09G 3/36

(52) U.S. Cl. CPC G09G 3/3648; G09G 2300/0809
USPC 345/212; 345/82

(57) ABSTRACT

An organic light emitting diode (OLED) display including: a substrate; a scan line formed on the substrate and configured to transmit a scan signal; a data line and a driving voltage line crossing the scan line and respectively configured to transmit a data signal and a driving voltage; a switch connected to the scan line and the data line; a static electricity shield enclosing the switch; and an organic light emitting diode (OLED) connected to the switch.

### CROSS-REFERENCE TO RELATED APPLICATION

This application claims priority from and the benefit of Korean Patent Application No. 10-2013-0093179, filed on Aug. 6, 2013, which is hereby incorporated by reference for all purposes as if fully set forth herein.

### BACKGROUND

1. Field

Exemplary embodiments of the present invention relate to an organic light emitting diode (OLED) display.

2. Discussion of the Background

An organic light emitting diode display includes two electrodes and an organic emission layer interposed therebetween, wherein electrons injected from a cathode and holes is injected from an anode form excitons in the organic emission layer, and light is emitted when the excitons discharge energy.

The organic light emitting diode display includes a plurality of pixels, each including an organic light emitting diode that is formed of a cathode, an anode, and an organic emission layer. Transistors and capacitors for driving the organic light emitting diode are formed in each pixel.

A thickness of an insulating layer for insulating metals such as a scan line, a data line, etc., is about 1000 Å, such that they are vulnerable to static electricity. Also, there are points that are susceptible to static electricity in nearly every driving circuit, where the static electricity may continuously arc. That is, when a pattern is not separately formed under the scan line, when the static electricity flows into the scan line, there is no outlet for the static electricity, such that the static electricity arcs into the transistor closest to the scan line. In this case, the scan line and the semiconductor layer may become connected such that a short circuit is generated, and a dark point is generated in the display due to the short circuit.

The above information disclosed in this Background section is only for enhancement of understanding of the background of the invention and therefore it may contain information that does not constitute prior art.

### BRIEF SUMMARY OF THE INVENTION

Exemplary embodiments of the present invention provide an organic light emitting diode (OLED) display in which static electricity is guided to a position where it cannot affect a switch.

Additional features of the invention will be set forth in the description which is follows, and in part will be apparent from the description, or may be learned by practice of the invention.

An organic light emitting diode (OLED) display according to an exemplary embodiment of the present invention includes: a substrate; a scan line disposed on the substrate and configured to transmit a scan signal; a data line and a driving voltage line insulated from and crossing the scan line and respectively configured to transmit a data signal and a driving voltage; a switch connected to the scan line and the data line; a static electricity shield enclosing the switch; and an organic light emitting diode (OLED) connected to the switch.

Additional features of the invention will be set forth in the description which follows, and in part will be apparent from the description, or may be learned by practice of the invention.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is an equivalent circuit of one pixel of an organic light emitting diode (OLED) display according to an exemplary embodiment of the present invention.

FIG. 2 is a layout view of one pixel of an organic light emitting diode (OLED) display according to an exemplary embodiment of the present invention.

FIG. 3 is a cross-sectional view taken along the line III-III of FIG. 2.

### DETAILED DESCRIPTION OF THE ILLUSTRATED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification. In addition, the size and the thickness of each element in the drawing are random samples for better understanding and ease of description, and the present invention is not limited thereto.

In the drawings, the thickness of layers, films, panels, regions, etc., are exaggerated for clarity. In the drawings, the thickness of some of layers and regions are exaggerated for better understanding and ease of description. It will be understood that when an element such as a layer, film, region, or substrate is referred to as being “on” another element, it can be directly on the other element or intervening elements may also be present.

In addition, unless explicitly described to the contrary, the word “comprise” and variations such as “comprises” or “comprising” will be understood to imply the inclusion of stated elements but not the exclusion of any other elements. Also, throughout the specification, “on” means that an element is positioned on or above or under or below another element, and may not necessarily mean that an element is positioned at an upper side of another element based on a gravitation direction.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

In addition, in the accompanying drawings, a 2Tr 1Cap structured active matrix (AM) type of organic light emitting diode (OLED) display, in which a pixel includes two transistors (TFT) and one capacitor, is illustrated. However, the present invention is not limited thereto. Therefore, the organic light emitting diode (OLED) display may have various structures in which a pixel may include a plurality of TFTs and at least one capacitor, a wiring line may be further formed, and a conventional wiring line may be omitted. Here, a pixel refers to a minimum unit that displays an image, and an OLED display displays an image through a plurality of pixels.

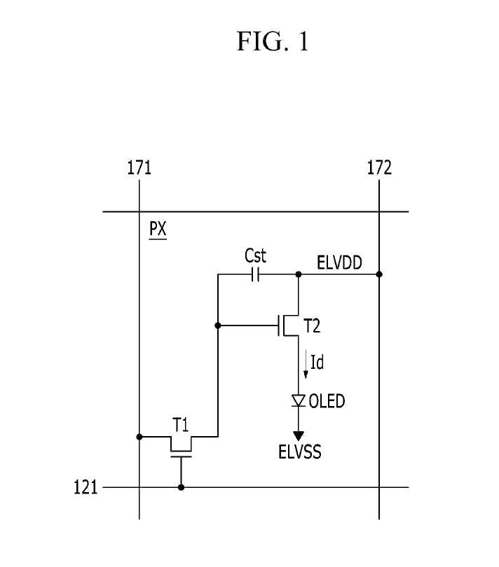

FIG. 1 is an equivalent circuit of one pixel of an organic light emitting diode (OLED) display according to an exemplary embodiment of the present invention. As shown in FIG. 1, the OLED display a includes a plurality of signal lines 121, 171, and 172 and a plurality of pixels PX connected to the signal lines 121, 171, and 172 and arranged in a matrix.

The signal lines include a plurality of scan lines 121 for transmitting scan signals (or gate signals), a plurality of data lines 171 for transmitting data signals, and a plurality of driving voltage lines 172 for transmitting a driving voltage ELVDD. The scan lines 121 run parallel with each other in a row direction, and the data lines 171 and the driving voltage lines 172 run parallel with each other in a column direction. Each pixel PX includes a switching transistor T1, a driving transistor T2, a storage capacitor Cst, and an organic light emitting diode (OLED).

The switching transistor T1 has a control terminal, an input terminal, and an output terminal. The control terminal is connected to the scan line 121, the input terminal is connected to the data line 171, and the output terminal is connected to the driving transistor T2. The switching transistor T1 transmits a data signal applied to the data line 171 to the driving transistor T2, in response to a scan signal applied to the scan line 121.

The driving transistor T2 has a control terminal, an input terminal, and an output terminal. The control terminal is connected to the switching transistor T1, the input terminal is connected to the driving voltage line 172, and the output terminal is connected to the organic light emitting diode OLED. The driving transistor T2 allows an output current Id, which varies in amplitude in accordance with a voltage applied between the control terminal and the input terminal, to flow.

The storage capacitor Cst is connected between the control terminal and the input terminal of the driving transistor T2. The storage capacitor Cst stores a data signal applied to the control terminal of the driving transistor T2, and maintains the data signal after the switching transistor T1 is turned off.

The organic light emitting diode OLED has an anode connected to the output terminal of the driving transistor T2, and a cathode connected to a common voltage ELVSS. The organic light emitting diode OLED displays an image by emitting light with different intensities, according to an output current Id of the driving transistor T2.

The switching transistor T1 and the driving transistor T2 may be n-channel field effect transistors (FETs) or p-channel FETs. The connection relationship among the transistors T1 and T2, the storage capacitor Cst, and the organic light emitting diode OLED may vary.

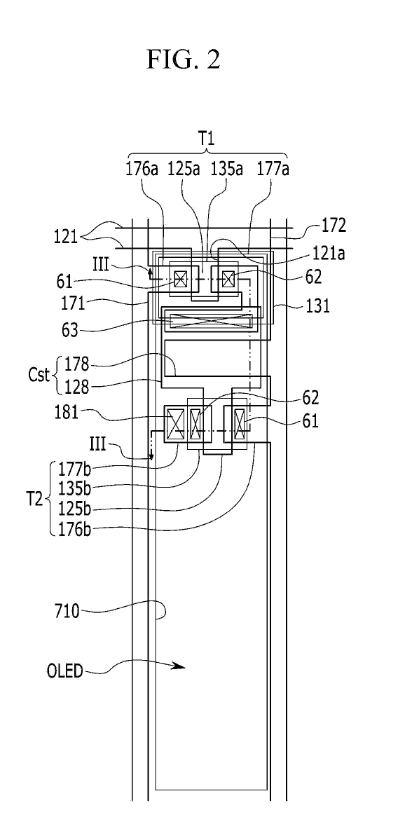

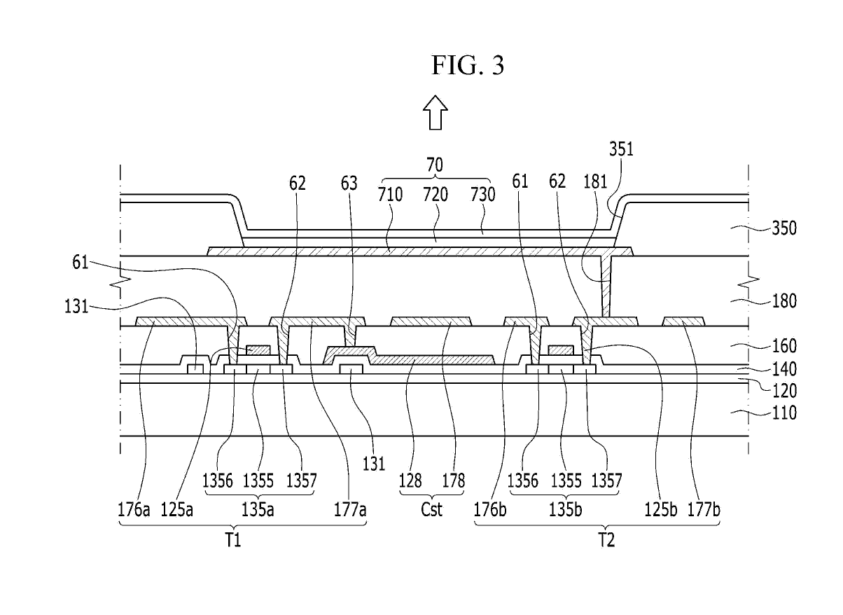

A detailed structure of the pixel of the OLED display shown in FIG. 1 will be described with reference to FIG. 2 and FIG. 3, as well as FIG. 1. FIG. 2 is a layout view of one pixel of an organic light emitting diode (OLED) display according to an exemplary embodiment is of the present invention, and FIG. 3 is a cross-sectional view taken along the line III-III of FIG. 2.

As shown in FIG. 2 and FIG. 3, a substrate 110 of an OLED display, according to an exemplary embodiment of the present invention, may be an insulative and/or flexible substrate made of glass, quartz, ceramic, plastic, etc.

A buffer layer 120 is formed in the substrate 110. The buffer layer 120 may have a single-layer structure of silicon nitride (SiNₓ), or a dual-layer structure of silicon nitride (SiNₓ) and silicon oxide (SiO₂) laminated to each other. The buffer layer 120 prevents the penetration of unwanted elements, such as impurities or moisture, and helps planarize the surface.

A switching semiconductor layer 135a and a driving semiconductor layer 135b are formed on the buffer layer 120, and are spaced apart from each other. Also, a static electricity shield 131 enclosing/surrounding the switching semiconductor layer 135a is formed on the buffer layer 120. In FIG. 2, the static electricity shield 131 encloses the switching semiconductor layer 135a with a square shape, however it is not limited thereto, and it may enclose with various shapes. For example, the static electricity shield 131 may completely surround the switching semiconductor layer 135a or may partially surround the switching semiconductor layer 135a.

These semiconductor layers 135a and 135b and the static electricity shield 131 may be made of a polysilicon or an oxide semiconductor. The oxide semiconductor may contain an oxide based on titanium (Ti), hafnium (Hf), zirconium (Zr), aluminum (Al), tantalum (Ta), germanium (Ge), zinc (Zn), gallium (Ga), tin (Sn), or indium (In), and complex oxides thereof, such as zinc oxide (ZnO), indium-gallium-zinc oxide (InGaZnO4), indium-zinc oxide (Zn—In—O), zinc-tin oxide (Zn—Sn—O), indium-gallium oxide (In—Ga—O), indium-tin oxide (In—Sn—O), indium-zirconium oxide (In—Zr—O), indium-zirconium-zinc oxide (In—Zr—Zn—O), indium-zirconium-tin oxide (In—Zr—Sn—O), indium-zirconium-gallium oxide (In—Zr—Ga—O), indium-aluminum oxide (In—Al—O), indium-zinc-aluminum oxide (In—Zn—Al—O), indium-tin-aluminum oxide (In—Sn—Al—O), indium-aluminum-gallium oxide (In—Al—Ga—O), indium-tantalum oxide (In—Ta—O), indium-tantalum-zinc oxide (In—Ta—Zn—O), indium-tantalum-tin oxide (In—Ta—Sn—O), indium-tantalum-gallium oxide (In—Ta—Ga—O), indium-germanium oxide (In—Ge—O), indium-germanium-zinc oxide (In—Ge—Zn—O), indium-germanium-tin oxide (In—Ge—Sn—O), indium-germanium-gallium oxide (In—Ge—Ga—O), titanium-indium-zinc oxide (Ti—In—Zn—O), and hafnium-indium-zinc oxide (Hf—In—Zn—O). If the semiconductor layers 135a and 135b are made of the oxide semiconductor, a separate protective layer (not shown) may be added to protect the oxide semiconductor from the outside environment and/or high temperatures.

The semiconductor layers 135a and 135b each include an undoped channel region and source and drain regions that are doped with impurities and are formed at respective sides of the channel region. The impurities vary according to the type of thin film transistor, and may be N-type impurities or P-type impurities.

The switching semiconductor layer 135a and the driving semiconductor layer 135b are each divided into a channel region 1355 and a source region 1356 and drain region 1357 formed at respective sides of the channel region 1355. The channel regions 1355 of the switching semiconductor layer 135a and the driving semiconductor layer 135b may include undoped polysilicon, that is, an intrinsic semiconductor, and the source regions 1356 and drain regions 1357 of the switching semiconductor layer 135a and the driving semiconductor layer 135b may include polysilicon doped with conductive impurities, that is, an impurity semiconductor.

A gate insulating layer 140 is formed on the switching semiconductor layer 135a, the driving semiconductor layer 135b, and the static electricity shield 131. The gate insulating layer 140 may be formed as a single layer or a plurality of layers containing at least one of silicon nitride and silicon oxide.

A scan line 121, a driving gate electrode 125b, and a first storage capacitor plate 128 are formed on the gate insulating layer 140. The scan line 121 longitudinally extends in a horizontal direction and transfers a scan signal, and includes a switching gate electrode 125a protruding from the scan line 121 toward the switching semiconductor layer 135a. The static electricity shield 131 overlaps a connection part 121a of the scan line 121, where the scan line 121 is connected to the switching gate electrode 125a. The driving gate electrode 125b protrudes from the first storage capacitor plate 128 toward the driving semiconductor layer 135b. The switching gate electrode 125a and the driving gate electrode 125b overlap the corresponding channel regions 1355.

When the static electricity flows in through the scan line 121, before the static electricity can flow to the switching semiconductor layer 135a of the switching transistor T1, the static electricity flows into the static electricity shield 131, such that the static electricity arcs to the static electricity shield 131. In particular, the static electricity may arc from the connection part 121a to an overlapping portion of the static electricity shield 131.

In this case, the scan line 121 and the static electricity shield 131 are short-circuited to each other, but the static electricity shield 131 does not affect the operation of the switching transistor T1. Thus, there is no influence caused by the static electricity.

As described above, by forming the static electricity shield enclosing the switching semiconductor layer of the switching transistor, the static electricity flowing through is the scan line arcs to the static electricity shield, before the switching gate electrode and the switching semiconductor layer are short-circuited, thereby protecting the switching transistor.

An interlayer insulating layer 160 is formed on the scan line 121, the driving gate electrode 125b, and the first storage capacitor plate 128. Like the gate insulating layer 140, the interlayer insulating layer 160 may be formed of silicon nitride or silicon oxide.

Source contact holes 61 and drain contact holes 62 are formed in the interlayer insulating layer 160 and the gate insulating layer 140 to expose the source regions 1356 and the drain regions 1357. Storage contact holes 63 are formed therein to expose parts of the first storage capacitor plate 128.

A data line 171 having a switching source electrode 176a, a driving voltage line 172 having a driving source electrode 176b and a second storage capacitor plate 178, and a switching drain electrode 177a and a driving drain electrode 177b that are connected to the first storage capacitor plate 128, are formed on the interlayer insulating layer 160.

The data line 171 transfers a data signal and extends in a direction crossing the gate line 121. The driving voltage line 172 transfers a driving voltage, is separated from the data line 171, and extends in the same direction as the data line 171.

The switching source electrode 176a protrudes from the data line 171 toward the switching semiconductor layer 135a. The driving source electrode 176b protrudes from the driving voltage line 172 toward the driving semiconductor layer 135b. The switching source electrode 176a and the source electrode 176b are respectively connected to the corresponding source regions 1356, through the source contact holes 61. The switching drain electrode 177a faces the switching source electrode 176a, the driving drain electrode 177b faces the driving source electrode 176b, and the switching drain electrode 177a and the driving drain electrode is 177b are respectively connected to the drain regions 1357 through the drain contact holes 62.

The switching drain electrode 177a is electrically connected to the first storage capacitor plate 128 and the driving gate electrode 125b, through the storage contact holes 63 formed in the interlayer insulating layer 160. The second storage capacitor plate 178 protrudes from the driving voltage line 172, and overlaps the first storage capacitor plate 128. Accordingly, the first storage capacitor plate 128 and the second storage capacitor plate 178 constitute the storage capacitor Cst, by using the interlayer insulating layer 160 as a dielectric material.

The switching semiconductor layer 135a, the switching gate electrode 125a, the switching source electrode 176a, and the switching drain electrode 177a constitute the switching thin film transistor T1. The driving semiconductor layer 135b, the driving gate electrode 125b, the driving source electrode 176b, and the driving drain electrode 177b constitute the driving thin film transistor T2.

A protective film 180 is formed on the switching source electrode 176a, the driving source electrode 176b, the switching drain electrode 177a, and the driving drain electrode 177b. A pixel electrode 710 is formed on the protective layer 180. The pixel electrode 710 may be made of a transparent conducting material, such as ITO (indium tin oxide), IZO (indium zinc oxide), ZnO (zinc oxide), or In₂O₃ (indium oxide), or a reflective metal, such as lithium (Li), calcium (Ca), lithium fluoride/calcium (LiF/Ca), lithium fluoride/aluminum (LiF/Al), aluminum (Al), silver (Ag), magnesium (Mg), or gold (Au). The pixel electrode 710 is electrically connected to the driving drain electrode 177b of the driving thin film transistor T2 through a contact hole 181 formed in the interlayer insulating layer 160, and serves as an anode of an organic light emitting diode 70.

A pixel defining layer 350 is formed on edge portions of the pixel electrode 710 and the protective film 180. The pixel defining layer 350 has an opening 351 exposing the pixel electrode 710. The protective film 180 may be made of a polyacrylate resin, a polyimide resin, a silica-based inorganic material, or the like.

An organic emission layer 720 is formed in the opening 351 of the pixel defining layer 350. The organic emission layer 720 may include one or more of an emission layer, a hole-injection layer (HIL), a hole-transporting layer (HTL), an electron-transporting layer (ETL), and an electron-injection layer (EIL). If the organic emission layer 720 includes all of these layers, the hole-injection layer may be positioned on the pixel electrode 710 serving as an anode, and the hole-transporting layer, the emission layer, the electron-transporting layer, and the electron-injection layer may be sequentially laminated on the pixel electrode 710.

The organic emission layer 720 may include a red organic emission layer for emitting red light, a green organic emission layer for emitting green light, and a blue organic emission layer for emitting blue light. The red organic emission layer, the green organic emission layer, and the blue organic emission layer are respectively formed in red, green, and blue pixels, thereby displaying a color image.

The red organic emission layer, green organic emission layer, and blue organic emission layer of the organic emission layer 720 may be respectively laminated on the red pixel, green pixel, and blue pixel, and a red color filter, a green color filter, and a blue color filter may be formed for the respective pixels, thereby displaying a color image. In another example, a white organic emission layer for emitting white light may be formed on all of the red, green, and blue pixels, and a red color filter, a green color filter, and a blue color filter may be formed for the respective pixels, thereby displaying a color image. If the white organic emission layer and is the color filters are used to display a color image, there is no need to use a deposition mask for depositing the red, green, and blue organic emission layers on the respective pixels, i.e., the red, green, and blue pixels.

The white organic emission layer described in this example may be formed as one organic emission layer or a plurality of organic emission layers that are laminated to emit white light. For example, at least one yellow organic emission layer and at least one blue organic emission layer may be combined to emit white light, at least one cyan organic emission layer and at least one red organic emission layer may be combined to emit white light, or at least one magenta organic emission layer and at least one green organic emission layer may be combined to emit white light.

A common electrode 730 is formed on the pixel defining layer 350 and the organic emission layer 720. The common electrode 730 may be made of a transparent conducting material, such as ITO (indium tin oxide), IZO (indium zinc oxide), ZnO (zinc oxide), or In2O3 (indium oxide), or a reflective metal such as lithium (Li), calcium (Ca), lithium fluoride/calcium (LiF/Ca), lithium fluoride/aluminum (LiF/Al), aluminum (Al), silver (Ag), magnesium (Mg), or gold (Au). The common electrode 730 serves as a cathode of the organic light emitting diode (OLED) 70. The pixel electrode 710, the organic emission layer 720, and the common electrode 730 constitute the organic light emitting diode (OLED) 70.

According to the present invention, by forming the static electricity shield enclosing the switching semiconductor layer of the switching transistor, the static electricity flowing through the scan line arcs to the static electricity shield, before the switching gate electrode and the switching semiconductor layer are short-circuited, thereby protecting the switching transistor.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An organic light emitting diode (OLED) display comprising:
a substrate;
a scan line disposed on the substrate and configured to transmit a scan signal;
a data line and a driving voltage line insulated from and crossing the scan line, the data line configured to transmit a data signal and the driving voltage line configured to transmit a driving voltage;
a switch connected to the scan line and the data line;
a static electricity shield disposed on the substrate surrounding the switch and configured to prevent static electricity from reaching the switch; and
an organic light emitting diode (OLED) connected to the switch.

2. The organic light emitting diode (OLED) display of claim 1, wherein the switch comprises a switching transistor.

3. The organic light emitting diode (OLED) display of claim 2, wherein the switching transistor comprises:
a semiconductor layer disposed on the substrate;
a gate insulating layer disposed on the semiconductor layer;
a gate electrode disposed on the gate insulating layer and extending from the scan line;
an interlayer insulating layer covering the gate electrode; and
a source electrode and a drain electrode formed on the interlayer insulating layer.

4. The organic light emitting diode (OLED) display of claim 3, wherein the static electricity shield is formed directly on the same layer as the semiconductor layer.

5. The organic light emitting diode (OLED) display of claim 3, wherein the static electricity shield surrounds the semiconductor layer.

6. The organic light emitting diode (OLED) display of claim 3, wherein the static electricity shield overlaps and crosses a connection part connecting the scan line and the gate electrode.

7. An organic light emitting diode (OLED) display comprising:
a substrate;
a scan line disposed on the substrate and comprising a connection part;
a data line and a driving voltage line insulated from and crossing the scan line;
a switching transistor comprising a semiconductor layer disposed on the substrate, a gate insulating layer disposed on the semiconductor layer, and a gate electrode disposed on the gate insulating layer and extending from the connection part;
a static electricity shield disposed on the substrate, surrounding the semiconductor layer, and overlapping with the connection part, and configured to receive static electricity from the scan line; and
an organic light emitting diode (OLED) connected to the transistor.

8. The organic light emitting diode (OLED) display of claim 7, further comprising:
a driving transistor configured to drive the OLED; and
a capacitor connected to the switching transistor and the driving transistor, the capacitor overlapping the static electricity shield.

9. The organic light emitting diode (OLED) display of claim 7, wherein the static electricity shield is disposed directly on the same layer as, and completely surrounds, the semiconductor layer.

10. The organic light emitting diode (OLED) display of claim 7, wherein the static electricity shield and the semiconductor layer are formed of the same material.
